(19) United States
(12) Patent Application Publication
(10) Pub. No.: US 2011/0149570 A1
(43) Pub. Date: Jun. 23, 2011

(54) MINIATURE TROUBLE LAMP

(76) Inventor: David A. Wenzlick, Mesa, AZ (US)

(21) Appl. No.: 12/914,999

(22) Filed: Oct. 28, 2010

Related U.S. Application Data
(60) Provisional application No. 61/255,677, filed on Oct. 28, 2009.

(51) Int. Cl. F21V 21/096; H01R 43/00

(52) U.S. Cl. 362/249.02; 29/825

(57) ABSTRACT

A trouble lamp has a generally transparent, cylindrical tube, a top end cap and an opposite bottom end cap disposed over the tube ends. A hanger has a stem inserted into the top end cap and a hook generally extending from the tube and the top end cap. An electrical cord extends from the bottom end cap to a plug configured to insert into a vehicle accessory socket. Magnets disposed at least partially within the tube top are configured to attach the trouble lamp to a ferrous metal surface. The hanger is configured to attach the trouble lamp to engine framework or wiring. An LED array disposed along the length of the tube is in communications with the cord so as to illuminate LEDs when the plug is inserted into the accessory socket.

### CROSS-REFERENCE TO RELATED APPLICATIONS

The present application claims priority benefit under 35 U.S.C. §119(e) to U.S. Provisional Patent Application Ser. No. 61/255,677, filed Oct. 28, 2009, titled Miniature Trouble Lamp, hereby incorporated by reference herein.

### BACKGROUND OF THE INVENTION

The terms “trouble light,” “work light,” “shop light” or “shop lamp” variously describe a device utilized by professionals such as repairmen, mechanics and technicians, as well as hobbyists, to illuminate a relatively small work area. In particular, a trouble light is frequently utilized by auto mechanics to illuminate engine compartment, transmission, undercarriage, axles, wheels, dashboard and other areas of an automobile. A conventional trouble light has a shielded conventional light bulb, reflector, socket and switch at one end of a long electrical cord extending to an AC plug.

### SUMMARY OF THE INVENTION

Conventional trouble lights are heavy, bulky and difficult to place in, attach to and aim into tight spaces. Further, conventional trouble lights generate significant heat and are prone to breakage when dropped, banged or driven over. Fluorescent bulbs are a common choice for automotive trouble lamps but they do not work well in cold temperatures and are slow to illuminate if at all in sub-zero conditions. LEDs actually get brighter when they are in freezing conditions and suffer no ill effects at from sub-zero conditions. A miniature trouble lamp (“lamp”) out-performs other lights for automotive work and similar applications. An advantageous feature of a lamp is its tiny size in comparison to most trouble lights, yet it outputs plenty of light to work in dark places. It casts a cool white light in a 180-degree viewing area while staying cool to the touch and consuming miniscule amounts of power. Being smaller and brighter than any other light in its class, a lamp can fit up inside the underside of a dash board or down behind the firewall of an engine compartment while still allowing ample room for hands and tools while working.

### BRIEF DESCRIPTION OF THE DRAWINGS

FIGS. 1A-B are LED-side and label-side views of a miniature trouble lamp (“lamp”) embodiment;

FIG. 2 is an exploded side view of external portions of a lamp;

FIG. 3 is an exploded LED-side view of internal portions of a lamp;

FIG. 4 is a detailed side view of a DC power plug;

FIG. 5 is a printed-side view of a lamp label;

FIGS. 6A-D are a side view, a sectional side view, a detailed hanger-end view and a detailed wire-end view, respectively, of a lamp;

FIG. 7 is an LED and plug schematic diagram;

FIGS. 8A-D are perspective, LED-side, edge and circuit-side views, respectively, of an LED strip; and

FIGS. 9A-E are detailed circuit-side, LED-side, edge, circuit-side perspective and LED-side perspective views, respectively, of a power wire-to-LED strip interface.

### DETAILED DESCRIPTION OF THE PREFERRED EMBODIMENTS

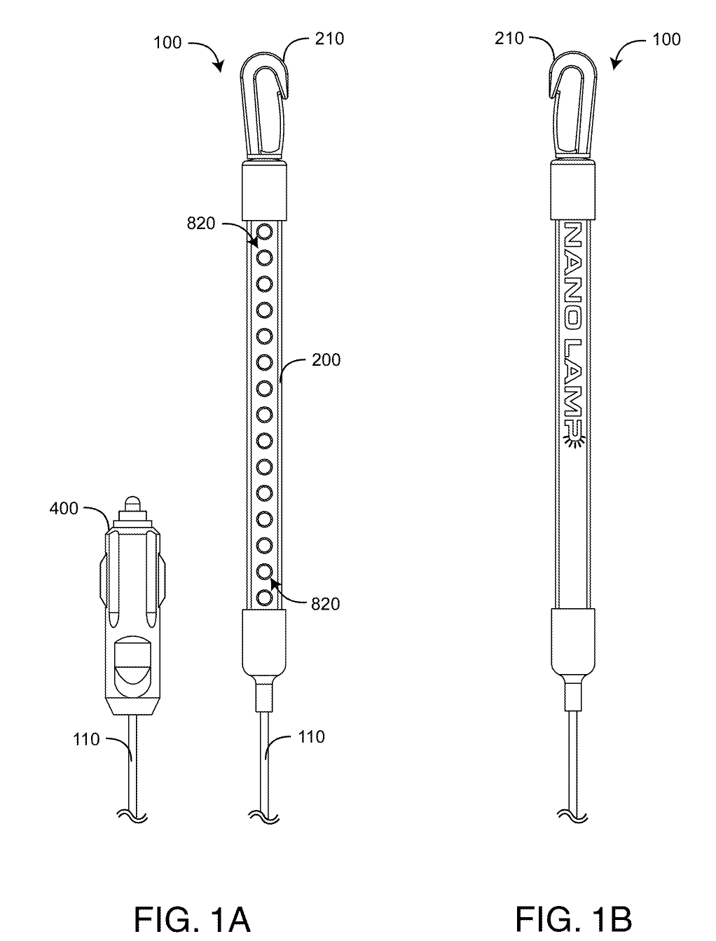

FIGS. 1A-B illustrate a miniature trouble lamp (“lamp”) 100 having a body 200, a power plug 400 and a cord 110 electrically interconnecting the body 200 and the plug 400. A hanger 210 extends from the body 200 and is utilized for attaching the lamp 100 to, say, an automobile engine framework or wiring. The lamp 100 utilizes LEDs 820 mounted within the body 200. In an embodiment, the LEDs 820 are designed for a high-definition, wide-angle illumination, as described below. The plug 400 inserts into a standard 12-volt DC accessory outlet, such as inside an automobile passenger compartment or provided by an AC/DC wall socket adapter. The lamp uses only 1/10 amp and, accordingly, is rated to operate in excess of 100,000 hours. As such, the lamp 100 could be accidentally plugged in for over a week with little effect to a normal automotive battery. The low-current design also means that the LEDs 820 will still produce usable light even if a car battery is discharged to the point where the battery cannot start a car. The lamp 100 is highly water-resistant and can be used in the rain without any concerns of safety or damage to the lamp. Due to the small size and the fact that it does not need internal batteries the lamp can be easily stored in the smallest of compartments for any length of time, always ready to use. Most portable or battery powered lamps will not fit in a glove box or center console. The compact size of the lamp and its adaptability to operate in a wide range of temperatures or weather conditions lamp makes it useful for motorcycle enthusiasts.

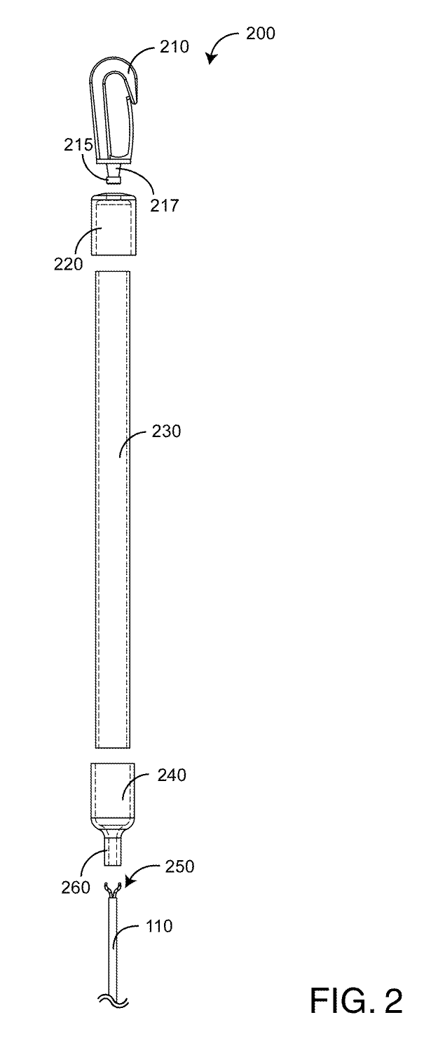

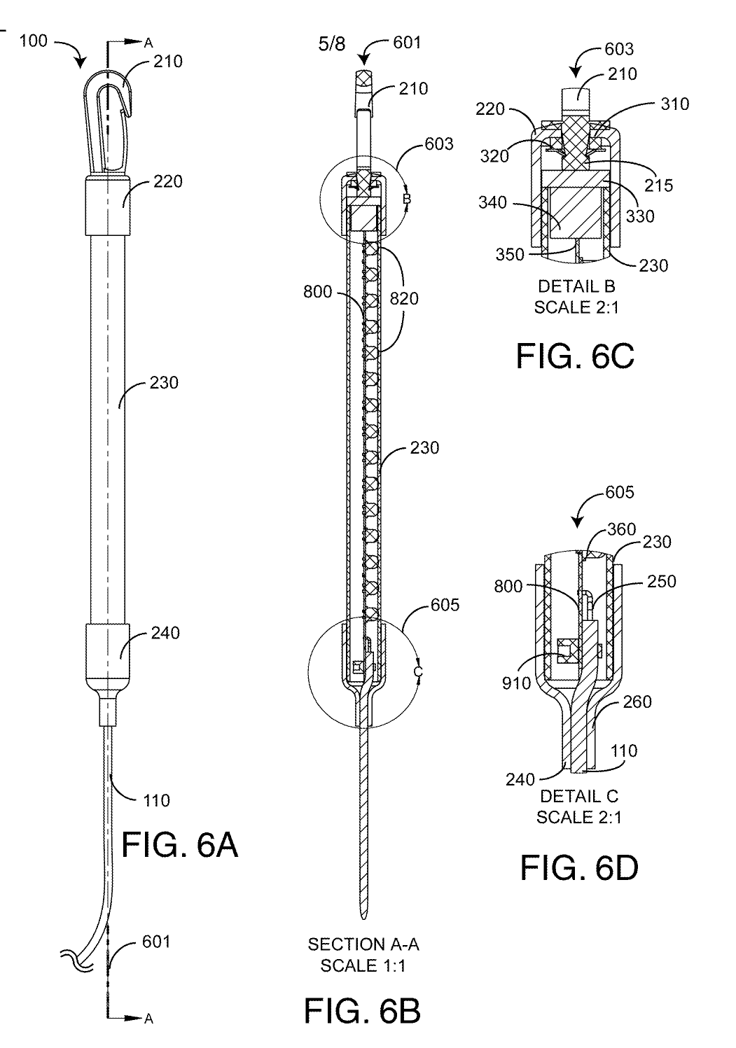

FIG. 2 further illustrates lamp 100 components including a hanger 210, a top end cap 220, a clear tube 230, a bottom end cap 240, a power cord 110, cord contact leads 250 and a cord strain-relief 260 integrated into the bottom end cap 240. The hanger 210 has an extended radius catch 215 at the end of a beveled stem 217 that extends into the top end cap 220, as described in detail with respect to FIG. 6C, below. In an embodiment, the hanger 210 is constructed of an extremely strong, reinforced nylon having in excess of 40 pounds tensile strength. In an embodiment, the tube 230 is hollow and constructed of extruded optical-grade polycarbonate using premium Bayer® brand virgin plastic pellets. Polycarbonate is highly impact and shatter resistant and commonly used to make optically-clear bullet-proof enclosures and safety glasses. The wall of the tube 230 is thick enough to allow for abusive handling and yet provide slight flexibility if stepped on or accidentally closed in a car door or hood. In an embodiment, the end caps 220, 240 are a soft vinyl to prevent scratching of any painted surfaces.

In an embodiment, the tube 230 is 7″ in length having a 0.50″ outside diameter a wall thickness of 0.050″ thickness (inside diameter of 0.40″). In other embodiments, other clear extrudable plastics are used for the tube, such as a styrene or acrylic. In various embodiments, the tube 230 could be tinted in various colors or different LEDs in a specified color could be used for particular applications, such as a road hazard indicator. A snap on colored cover on the tube is used in another embodiment.

In an embodiment, the cord 110 is constructed of 16 feet of 22 gauge wire. The cord length allows the user to reach nearly any part of a vehicle when plugged into the standard 12-volt accessory outlet inside a passenger compartment. A convenient Velcro® brand bundle-tie attaches to the cord for cord management during storage. A spacer/friction washer 310 and retainer clip 320 under the top end cap 220 provides an adjustable, secure grip of the hanger 210 to the end cap 220, as shown in detail in FIG. 6C, below. This feature allows the trouble lamp to be indexed to an exact working position without spinning to an unwanted direction.

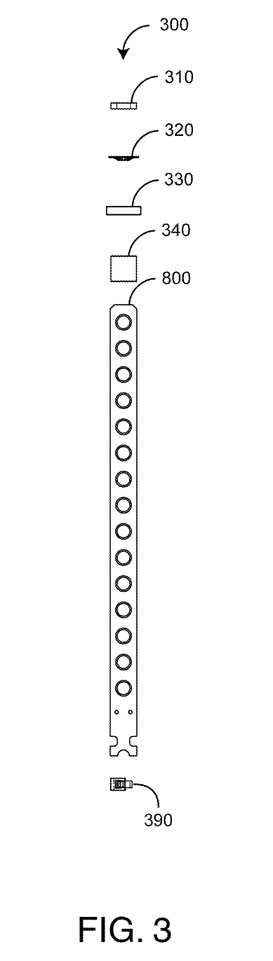

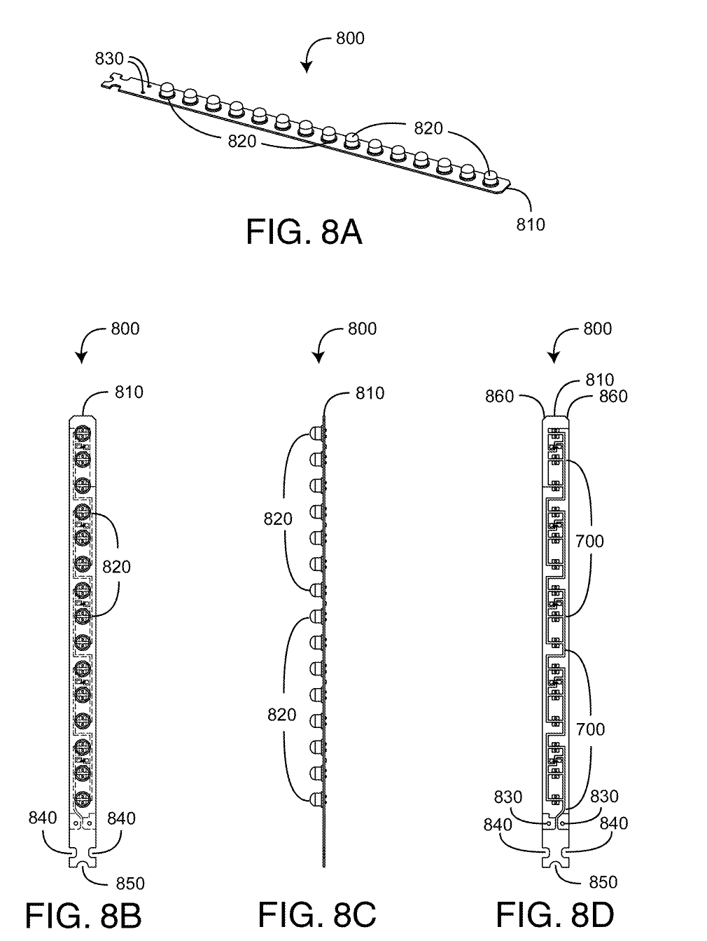

FIG. 3 illustrates internal lamp portions 300, including a spacer 310, a retainer clip 320, a first magnet 330, a second magnet 340, and an LED strip 800. In an embodiment, the first and second magnets 330, 340 are neodymium magnets having staggered diameters so as to be stacked and hidden under the top end cap 220 (FIG. 2). This allows the lamp to securely attach to any ferrous metal surfaces. Stacking the magnets 330, 340 and staggering the magnet outside diameters advantageously allows the magnetic flux to be concentrated closest to the inside diameter of the top end cap 220. This magnetic arrangement advantageously provides the lamp with a substantial holding force to a ferrous metal surface without exposing the magnets. In particular, the top magnet 330 s not inside of the clear tube so that its larger OD can be closer to an external metallic object for attachment. The lower magnet 340 adds to the magnetism of the upper magnet and helps concentrate the magnetic pull into the upper magnet ring. In an embodiment, the first magnet 330 has an outside diameter of 0.50 inches and 0.125 inch thickness and the second magnet 340 has an outside diameter of 0.375 inches and 0.375 inch thickness. Both magnets 330, 340 are captured between the circuit board and the swivel/vinyl top cap assembly. The LED strip 800 is described in further detail with respect to FIGS. 8A-D, below.

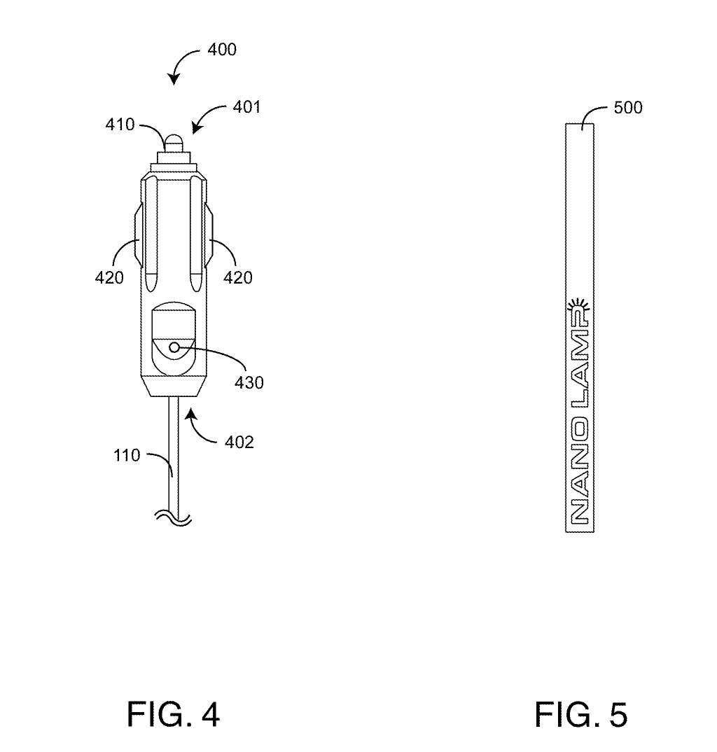

FIG. 4 illustrates the power plug 400, which is a generally cylindrical device having a contact end 401 and a cord end 402. The power plug 400 is configured to insert contact end first into a vehicle accessory (lighter) socket so as to provide power to the trouble lamp 100 (FIG. 1) via the cord 110. The power plug 400 has a plus voltage contact 410 generally centered at the contact end 401 and a plurality of negative voltage contacts 420 around the plug walls. The power plug 400 is fused to safely disconnect power quickly if more than 1 amp of current attempts to flow in the circuit. The 1 amp fuse (not shown) provides a high level of safety if the cord accidentally gets cut or pinched. Since the LEDs only require 0.1 amp the fuse will never fail from normal daily use. The fuse is replaceable by the end user if required. A tiny red LED 430 within the power plug 400 indicates when the user has a good connection to the accessory socket power source.

FIG. 5 illustrates a lamp label 500 having a printed side (shown) and a foil side. The label 500 has a printed layer and a backing layer. The printed layer is a self-adhesive 2-mil metallized polyester with flexo-applied UV ink. The backing layer is a formed thin aluminum foil used to keep the label straight and provide rigidity during assembly. In an embodiment, the label is 6.0″×0.50″ and the foil backing is 0.005″ aluminum.

FIGS. 6A-D illustrate various lamp assemblies including a tube assembly 601 (FIG. 6B), a top end cap assembly 603 (FIG. 6C) and the bottom end cap assembly 605 (FIG. 6D). As shown in FIG. 6B, the tube assembly 601 has the LED strip 800 that mounts the LEDs 820 held by interference fit within the tube 230, so that the LEDs may radiate out the side of the tube.

As shown in FIG. 6C, the top end cap assembly 603 has a spacer 310 and a retainer clip 320 that secures the hanger catch 215 within the top end cap 220. The top end cap 220 is secured over the top end of the tube 230. A first magnet 330 is secured between the hanger catch 215 and the tube 230 wall. A second magnet 340 is secured magnetically to the first magnet 330 within the tube 230 proximate the first magnet 330.

As shown in FIG. 6D, the bottom end cap assembly 605 has the power cord 110 inserted within the bottom end cap 240. The bottom end cap 240 is secured over the bottom end of the tube 230. In an embodiment, the top end cap 220 and the bottom end cap 240 are secured to the tube 230 using a cyanoacrylate adhesive. The cord contact leads 250 are soldered to the LED strip 800. In an embodiment, the cord 110 is retained with a cable tie 910 inside the bottom end cap 240. A strain relief 260 is built into the bottom end cap 240.

In an embodiment, the top end cap 220 is a vinyl and is a press fit on the tube as well as being glued. The outside length is 0.85″, the inside length is 0.75″, the OD relaxed is 0.60″, the ID relaxed is 0.48″ and the wall thickness is 0.060″. In an embodiment, the bottom cap is vinyl and is press fit on the tube as well as being glued. The outside length overall is 1.500″, the inside length to strain relief is 0.75″, the strain relief length only is 0.75″, the OD relaxed is 0.60″, the ID relaxed is 0.48″ (strain relief ID 0.125″) and the wall thickness 0.60″

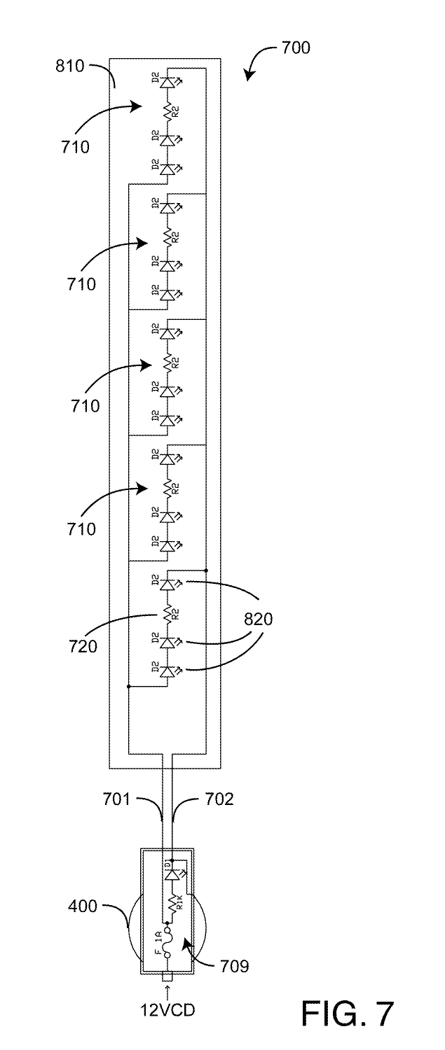

FIG. 7 illustrates an LED circuit 700 and plug circuit 709. In an embodiment, the LED circuit 700 has five LED groups 710 electrically connected in parallel between the 12 VDC power rail 701 and the ground rail 702. Each LED group 710 has three LEDs 820 in series with a resistor 720. In an embodiment, the resistors 720 are small surface mount ¼ watt resistors soldered on the rear of the circuit board 810. The resistors 720 are selected as required based upon the forward voltage of the LEDs and are used to limit the maximum current that can flow through the LEDs. As not all LEDs, even from the same manufacturer, have exactly the same forward voltage from batch to batch, a nominal 120 ohm resistor value may increase or decrease so as to match the LEDs. In particular, the LED supplier provides the LED specs and the resistors 720 are selected at the time of assembly to match those specs.

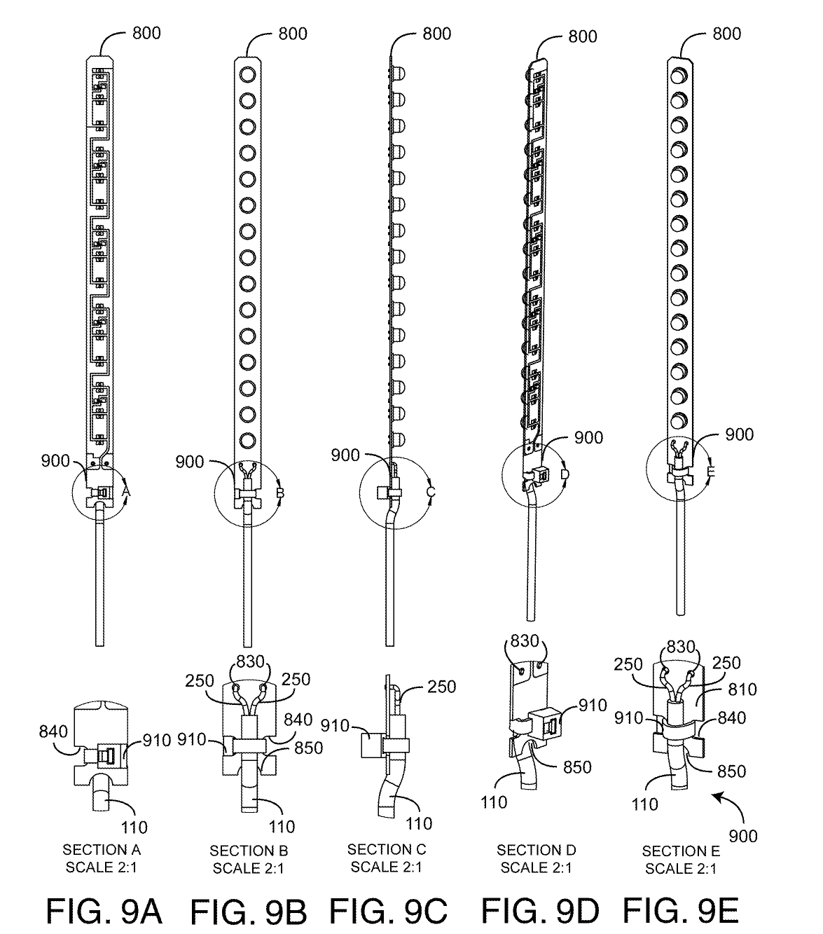

FIGS. 8A-D illustrate an LED strip 800 having a circuit board 810, LEDs 820 mounted on and electrically connected to the circuit board 810 and cord contacts 830. The board has 45 degree bevels 860 that advantageously facilitate insertion of the board 810 into the tube 230 during manufacture. In an embodiment, the cord contacts 830 are plated thru-holes that solder to the cord leads 250 (FIGS. 9B, 9E) to provide LED current via the plug 400 (FIG. 1). In an embodiment, the lamp 100 utilizes an array of cool-white LEDs 820, which are preferred by most professionals when doing technical work. In an embodiment (not shown) there are fifteen LEDs comprising five groups of three LEDs each. The LEDs 820 disperse light in a very wide, smooth pattern so that repositioning the light is not required, such as when working with small flashlights or similar devices that have a “spot” illumination design. In an embodiment, the LEDs are hi-definitions, i.e. have a 5000K color temperature light spectrum output. The LEDs are wide-angle (120-degrees) 20 mA forward voltage. The 5000K color temperature advantageously matches natural sun light and gives the best color rendition while working on colored objects, such as color-coded wires.

In an embodiment, the board 810 overall dimensions are thickness 0.060″, width 0.390″ and length 6.625″. In an embodiment, the board 810 is an industry standard epoxy/fiberglass construction having a black top coating for appearance instead of the usual green color or brown. Black is used for cosmetic reasons only. The board 810 has a single-side copper trace construction having a copper thickness of 1 ounce per square foot, i.e. about 0.0014″ thick (1.4 mils). The copper traces are tin plated for better solderability. There are no copper traces on the LED side of the board.

FIGS. 9A-E illustrate a power cord to LED strip interface having two opposing zip tie notches 840 to provide room for the zip tie (such as “Zip-Ty” brand) that is used to securely retain the power cord to the circuit board 810. An end notch 850 prevents chafing of the power cord 110 as it exits through the end cap 240 (FIG. 2). The power cord leads 250 are soldered into lead holes 830.

A trouble light has been disclosed in detail in connection with various embodiments. These embodiments are disclosed by way of examples only and are not to limit the scope of the claims that follow. One of ordinary skill in art will appreciate many variations and modifications and advantages of these variations and modifications.

In various embodiments, the lamp utilizes a self-contained, battery powered by, for example, tiny rechargeable Lithium polymer cells and recharged by a removable power cord that can remain connected for extended use. The lamp can be manufactured in longer versions and shorter versions. The lamp can be assembled using hidden magnets at both ends instead of just at the top. The LEDs can bed configured for on/off blinking or sequentially blinking for road hazard use. Many colors LEDs can be utilized including UV wavelength for leak detection with fluorescing dyes. In an embodiment, the lamp hook at the top end is replaced with a small traditional flashlight reflector. For road hazard use, narrow angle LEDs having viewing angles as small as 5-degrees can be utilized in order to illuminate to a much further distance.

In an embodiment, the lamp is built fully self-contained with batteries and with pressure seals at each end for boating applications. Advantageously, the self-contained lamp of this embodiment is useful for clearing debris from under a boat, changing a broken propeller at night on a small fishing boat or other applications requiring lengthy immersion in water or other fluids.

1. A trouble lamp comprising:
a generally transparent, cylindrical tube having an open top end and an open bottom end;
a top end cap press fit over the tube top end so as to generally enclose the top end;
a bottom end cap press fit over the tube bottom end so as to generally enclose the bottom end;
a hanger having a hook and a stem, the stem inserted into the top end cap and the hook generally extending distal the tube top end;
a cord having a first end extending into the bottom end cap and a second end terminating at a plug;
a plurality of magnets disposed at least partially within the tube top end and retained at least partially within the top end cap;
an LED array disposed along the length of the tube; and
the cord in electrical communications between the plug and the LED array so as to illuminate the LED array when the plug is inserted into a vehicle accessory socket.

2. The trouble lamp according to claim 1 wherein:
the magnets comprise a magnet stack having a relatively larger OD magnet and a relatively smaller OD magnet;
the smaller OD magnet is at least partially disposed within the tube; and
the larger OD magnet is disposed outside of the tube under the top end cap.

3. The trouble lamp according to claim 2 further comprising:
a generally thin, elongated circuit board having a length extending between a bottom end and a top end;
a plurality of conductive traces extending along the length of the circuit board from a power cord interface disposed proximate the bottom end;
the cord first end electrically connected to the power cord interface;
the LED array uniformly mounted along the circuit board and electrically connected to the conductive traces; and
the circuit board width dimensioned so as to provide an interference fit within the tube.

4. The trouble lamp according to claim 3 further wherein:
the conductive traces define a power rail and a ground rail;
the LED array is connected between the power rail and the ground rail in a plurality of LED groups; and
each LED group having three LEDs electrically connected in series with a current limiting resistor matched to the LEDs.

5. The trouble lamp according to claim 4 wherein the hanger is rotatably secured to the top end cap so as to allow the lamp to attach to an external object and to be indexed to an exact working position without unwanted spinning.

6. The trouble lamp according to claim 5 further comprising:
an extended radius catch disposed at one end of the hanger stem;
a friction fit washer disposed within the top end cap and around the stem; and
a retainer clip disposed on the catch so as to secure the hanger to the top end cap.

7. The trouble lamp according to claim 5 further wherein the tube is extruded polycarbonate having a length of about 7 inches, an outside diameter of about 0.50 inches and a wall thickness of about 0.050 inches.

8. A trouble lamp method comprising:
assembling an LED strip;
positioning the LED strip in a clear, elongated tube having open ends;
enclosing the tube open ends with a top end cap and a bottom end cap;
attaching a hanger to the top end cap;
capturing a magnet assembly between the top end cap and the tube; and
connecting an electrical cord to the LED strip through the bottom end cap.

9. The trouble lamp method according to claim 8 wherein capturing a magnet assembly comprises:
disposing a first magnet within the top end cap; and
disposing a second magnet within the tube between the first magnet and the LED strip.

10. The trouble lamp method according to claim 9 wherein assembling an LED strip comprises:
providing a circuit board having plurality of conductive traces;
defining a power trace and a ground trace of the conductive traces; and
mounting a plurality of LED groups in parallel between the power trace and the ground trace, where each of the LED groups is a series connection of LEDs.

11. The trouble lamp method according to claim 10 wherein positioning the LED strip comprises interference fitting the circuit board and mounted LEDs within the elongated tube.

12. The trouble lamp method according to claim 11 wherein attaching a hanger comprises:
inserting a hanger stem through the top end cap;
friction fitting a washer within the top end cap so as to be disposed around the hanger stem; and
securing a retainer clip on an extended radius catch portion of the hanger stem.

13. The trouble lamp method according to claim 12 wherein connecting comprises:
inserting an electrical cord end through the bottom end cap;
defining a power interface extending from the power trace and ground trace;
electrically connecting the cord end to the power interface; and
mechanically securing the cord end to the circuit board.

14. The trouble lamp method according to claim 13 further comprising current limiting each of the LED groups.

15. A trouble lamp comprising:
a generally transparent, cylindrical tube having an open top end and an open bottom end;
a circuit board disposed within and held with an interference fit along a length of the tube a plurality of LEDs disposed on the circuit board;
a top end cap generally sealing the open top end;
a bottom end cap generally sealing the open bottom end;
a hanger extending from the top cap so as to hook the lamp to a variety of objects; and
an electrical cord having a plug end and a open wire end, the open wire end extending through the bottom cap and terminating at a power interface on the circuit board; and
the power interface in electrical communication with the LEDs so as to illuminate the LEDs when the plug end is inserted into a DC accessory outlet.

16. The trouble lamp according to claim 15 further comprising a magnetic assembly disposed proximate the top end cap so as to magnetically attach the lamp to a variety of ferrous metal objects.

17. The trouble lamp according to claim 16 further comprising:
a first cylindrical rare earth magnet having a first diameter and a first length;
a second cylindrical rare earth magnet having a second diameter and a second length;
the first diameter is greater than the second diameter;
the first length less than the second length;
the first magnet is disposed within the top end cap proximate the hanger, the first diameter generally matching an outer diameter of the tube and the inner diameter of the top end cap so that the first magnet is removably retained by the top end cap proximate an end of the tube; and
the second diameter generally matching the tube inner diameter so that the second magnet extends into the tube.

18. The trouble lamp according to claim 17 wherein the circuit board is configured with conductive traces so as to organize the LEDs into a plurality of series connected groups connected between a power trace and a ground trace.

19. The trouble lamp according to claim 18 wherein the hanger comprises:
a hanger stem disposed through the top end cap;
a washer friction-fitted within the top end cap so as to be disposed around the hanger stem; and
a retainer clip disposed on the hanger stem.

20. The trouble lamp according to claim 19 further comprising:
a plurality of notches defined in the circuit board proximate the power interface; and
a cable tie disposed around the cord and the notches so as to secure the cord to the circuit board.
